(19) United States
(12) Patent Application Publication
(10) Pub. No.: US 2013/0249504 A1
(43) Pub. Date: Sep. 26, 2013

(54) POWER FACTOR CORRECTION (PFC) CONTROLLER AND BRIDGELESS PFC CIRCUIT WITH THE SAME

(71) Applicant: TA-CHING HSU, TAIPEI CITY (TW)

(72) Inventor: TA-CHING HSU, TAIPEI CITY (TW)

(73) Assignee: NIKO SEMICONDUCTOR CO., LTD., NEW TAIPEI CITY (TW)

(21) Appl. No.: 13/429,419

(22) Filed: Mar. 25, 2012

(51) Int. Cl. G05F 1/70

(52) U.S. Cl. 323/207

(57) ABSTRACT

A power factor correction (PFC) controller for controlling at least a switching unit is provided. The PFC controller has a feedback control circuit, a conductive current detecting circuit, and a switching control circuit. The feedback control circuit generates a feedback control signal for turning off the switch according to a feedback voltage signal. The conductive current detecting circuit has a clamp circuit, which generates a clamped signal restricted in a positive potential varying range according to a negative potential portion of a conductive-current detecting signal, and generates a cutoff signal for turning off the switch according to at least the clamped signal. The switching control circuit is utilized for controlling the switch according to the feedback control signal and the cutoff signal.

### BACKGROUND OF THE INVENTION

(1) Field of the Invention

This invention relates to a power factor correction (PFC) controller and application circuits with the same, and particularly relates to a PFC controller for a bridgeless PFC circuit.

(2) Description of the Prior Art

Environmental protection and power conservation has become an important issue nowadays. The trend of improving power efficiency of isolated ac power suppliers is directed to the development of topologies of secondary side synchronous rectifier control and primary side power factor correction (PFC) control.

FIGS. 1A and 1B are schematic views showing a typical full-bridge PFC application circuit. As shown, the application circuit includes a bridge rectifier circuit and a DC-to-DC convertor. Power provided by the ac power source is converted into DC power first and then converted by the DC-to-DC converter to generate the output voltage Vo for driving the load Ro.

As shown, during the positive half cycles of the ac voltage input from the ac power source, the current flows from the ac power source, through the diode d1, the inductor Li, the turned-on switching unit sw0, the diode d4, and back to the ac power source. As the switching unit sw0 is turned off, the inductor Li releases energy to establish an energy-releasing current flowing from the inductor Li, through the diode do, load Ro, diode d4, ac power source, diode d1, and back to the inductor Li. During the negative half cycles of the ac voltage input from the ac power source, the current flows from the ac power source, through the diode d2, the inductor Li, the turned-on switching unit sw0, and the diode d3, and back to the ac power source. As the switching unit sw0 is turned off, the inductor Li releases energy to establish an energy-releasing current flowing from the inductor Li, through the diode do, load Ro, diode d3, ac power source, diode d2, and back to the inductor Li.

The application of power factor correction topology nowadays is deviated to bridgeless designs. Bridgeless PFC topology combined the separated bridge rectifier control and PFC control in the traditional topology into a common circuit such that rectifying voltage drop in the bridge rectifier can be reduce to enhance overall power efficiency.

FIGS. 2A and 2B are schematic views showing a typical bridgeless PFC application circuit operated during the positive half cycles and the negative half cycles of the ac voltage input. As shown, the application circuit integrates the four diodes in the aforementioned bridge rectifier circuit and the PFC circuit and features two diodes d5, d6 and two switching units sw1, sw2 for replacing the function of the bridge rectifier circuit. With the on/off state of the switching units sw1, sw2 be properly controlled, the object of the PFC application circuit can be achieved. As shown, during the positive half cycles of the ac voltage input provided by the ac power source, the current flows from the ac power source, through the inductor Li, the conducted switching units sw1 and sw2, and back to the ac power source for charging the inductor Li. As the switching units sw1 and sw2 are turned off, the inductor Li releases energy to establish an energy-releasing current flowing from the inductor Li, through the diode d5, the load Ro, the body diode ds2 of the switching unit sw2, and back to the inductor Li.

During the negative half cycles of the ac voltage input from the ac power source, the current flows from the ac power source, through the conducted switching units sw2 and sw1, the inductor Li, and back to the ac power source for charging the inductor Li. As the switching units sw1 and sw2 are turned off, the inductor Li releases energy to establish an energy-releasing current flowing from the inductor Li, through the ac power source, the diode d6, the load Ro, the body diode ds1 of the switching unit sw1, and back to the inductor Li.

For a bridge PFC application circuit, there needs two diodes on the current path for bridge rectifying. Conduction loss from the diodes may affect overall conversion efficiency. In contrast, bridgeless PFC application circuits have the advantage of fewer rectifying diodes on the current path and thus voltage drop and energy loss from the diode can be effectively reduced.

FIGS. 3A and 3B are schematic views showing another typical bridgeless PFC application circuit operated during the positive half cycles and the negative half cycles of the ac voltage input. The application circuit adopts a totem pole driver and an additional high-side driver is demanded. Driving control for the application circuit is more complicated than that shown in FIGS. 2A and 2B.

As shown, during the positive half cycles of the ac voltage input from the ac power source, the current flows from the ac power source, through the inductor Li, the conducted switching unit sw4 and the diode d8, and back to the ac power source for charging the inductor Li as the switching unit sw3 is turned off. On the other hand, as the switching unit sw4 is turned off and the switching unit sw3 is turned on, the energy-releasing current generated by the inductor Li flows from the inductor Li, through the conducted switching unit sw3, the load Ro, the diode d8, and back to the inductor Li.

During the negative half cycles of the ac voltage input provided by the ac power source, the current flows from the ac power source, through the diode d7, the conducted switching unit sw3, the inductor Li, and back to the ac power source for charging the inductor Li as the switching unit sw4 is turned off. On the other hand, as the switching unit sw3 is turned off and the switching unit sw4 is turned on, the energy-releasing current generated by the inductor Li flows from the inductor Li, through the ac power source, the diode d7, the load Ro, the conducted switching sw4, and back to the inductor Li.

The inductor Li in the aforementioned two bridgeless PFC application circuits needs to be charged and discharged no matter during the positive half cycles output or the negative half cycles output from the ac power source. That is, the switching units sw1, sw2, sw3, sw4 should be adequately controlled during both half cycles. Thus, the difficulty for detecting inductor current and current state of the switching unit to properly control the switching units sw1, sw2, sw3, and sw4 is unpreventable.

### SUMMARY OF THE INVENTION

It is a main object of the present invention to provide a PFC control circuit, which is capable to detect inductor current of both directions attended with the positive and negative half cycles of the output from the ac power source.

It is another object of the present invention to provide a PFC controller, which is able to detect conductive current of the switching unit on matter during the positive half cycles or the negative half cycles of the output from the ac power source.

According to an embodiment of the present invention, a power factor correction (PFC) controller for controlling at least a switching unit is provided. The PFC controller includes a feedback control circuit, a conductive current detecting circuit, and a switching control circuit. The feedback control circuit generates a feedback control signal for controlling the switching unit according to a feedback voltage signal. The conductive current detecting circuit includes a second clamp circuit, which generates a second clamped signal restricted in a positive potential varying range at least according to a negative potential portion of a conductive-current detecting signal, and generates a cutoff signal to turn off the switching unit at least according to the second clamped signal. The switching control circuit is utilized for turning off the switching unit according to the feedback control signal and the cutoff signal.

According to another embodiment of the present invention, a bridgeless PFC circuit is provided. The bridgeless PFC circuit includes a converting circuit, a switching unit current detector, and a PFC controller. The converting circuit has a high-side line and a low-side line and also includes a first high-side rectifier unit, a first low-side rectifier unit, a second high-side rectifier unit, a second low-side rectifier unit, at least an inductor, and an output capacitor. The first high-side rectifier unit and the first low-side rectifier unit are serially connected between the high-side line and the low-side line and a first node is defined on a circuit between the first high-side rectifier unit and the first low-side rectifier unit. The second high-side rectifier unit and the second low-side rectifier unit are serially connected between the high-side line and the low-side line and a second node is defined on a circuit between the second high-side rectifier unit and the second low-side rectifier unit. The inductor is connected between a power source and the first node. The inductor and the power source are serially connected between the first node and the second node. The output capacitor is connected between the high-side line and the low-side line. At least one of the first high-side rectifier unit, the first low-side rectifier unit, the second high-side rectifier unit, and the second low-side rectifier unit is a switching unit.

The switching unit current detector is connected to the switching unit for detecting a conductive current flowing through the switching unit to generate a conductive-current detecting signal. The PFC controller includes a feedback control circuit, a conductive current detecting circuit, and a switching control circuit. The feedback control circuit generates a feedback control signal for controlling the switching unit according to a feedback voltage signal with respect to an output voltage of the converting circuit. The conductive current detecting circuit includes a second clamp circuit, which generates a second clamped signal restricted in a positive potential varying range at least according to a negative potential portion of the conductive-current detecting signal, and generates a cutoff signal for turning off the switching unit at least according to the second clamped signal. The switching control circuit is utilized for turning off the switching unit according to the feedback control signal and the cutoff signal.

### BRIEF DESCRIPTION OF THE DRAWINGS

The present invention will now be specified with reference to its preferred embodiment illustrated in the drawings, in which:

FIGS. 1A and 1B are schematic views showing a typical full-bridge PFC application circuit.

FIGS. 2A and 2B are schematic views showing a typical bridgeless PFC application circuit.

FIGS. 3A and 3B are schematic views showing another typical bridgeless PFC application circuit.

FIG. 4 is a schematic view showing a PFC application circuit in accordance with an embodiment of the present invention.

FIG. 5 is a schematic view showing a PFC application circuit in accordance with another embodiment of the present invention.

FIG. 6 is a schematic view showing a bridgeless PFC application circuit in accordance with still another embodiment of the present invention.

FIG. 7 is a schematic view of a PFC controller in accordance with an embodiment of the present invention.

FIG. 8 is a waveform diagram showing the operation of the PFC application circuit in FIG. 6.

FIGS. 9A and 9B are waveform diagrams showing the operation of the zero-current detecting circuit in FIG. 7.

FIGS. 10A and 10B are waveform diagrams showing the operation of the conductive current detecting circuit in FIG. 7.

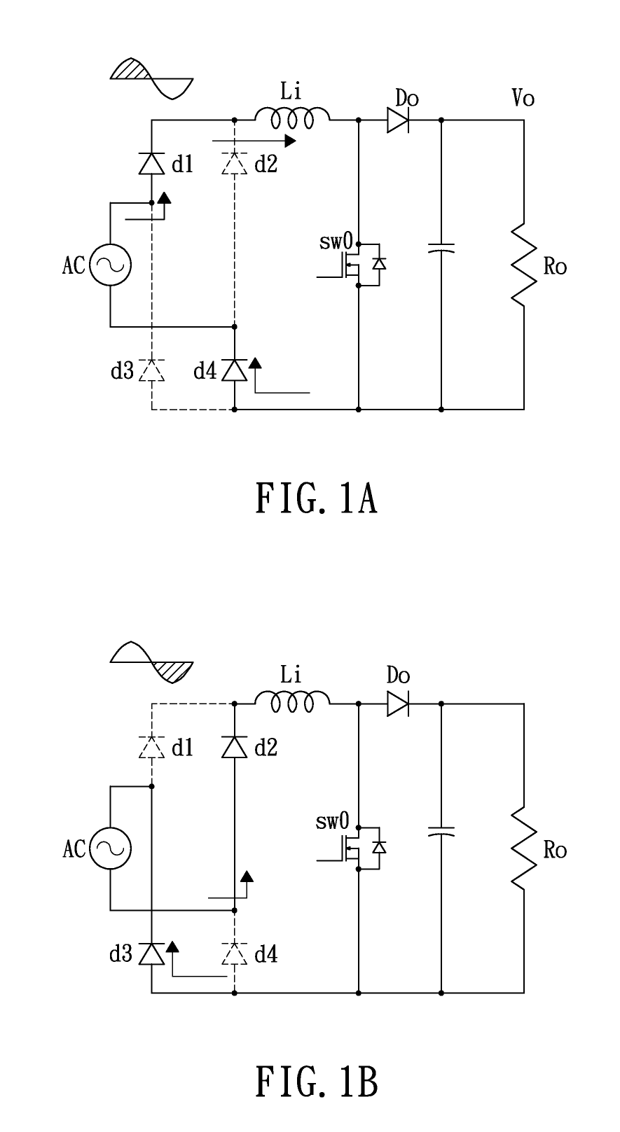

### DESCRIPTION OF THE PREFERRED EMBODIMENT

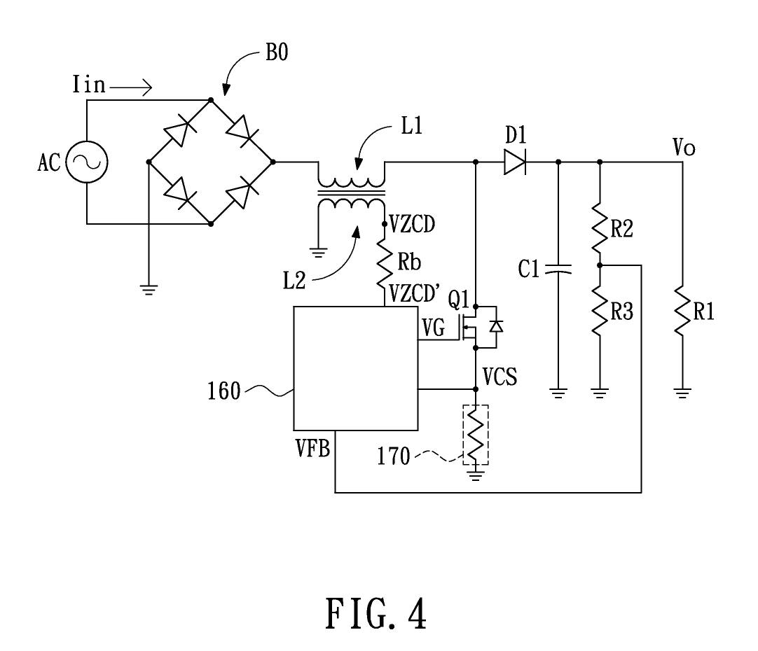

FIG. 4 is a schematic view showing an application circuit for a power factor correction (PFC) controller in accordance with an embodiment of the present invention. As shown, the application circuit includes a bridge rectifier circuit B0 and a DC-to-DC converter circuit. The voltage input from the ac power source is first converted to a DC output by the bridge rectifier circuit B0, and then the DC output is converted into the output voltage Vo by the DC-to-DC converter circuit supplied to the load R1.

The DC-to-DC converter circuit includes an inductor L1, a switching unit Q1, a diode D1, a capacitor C1, a switching unit current detector 170, an auxiliary inductor L2, a voltage divider composed of resistors R2 and R3, and a PFC controller 160. The switching unit current detector 170 includes a resistor serially connected to the switching unit Q1 for detecting the conductive current flowing through the switching unit Q1 so as to generate a conductive-current detecting signal VCS. The auxiliary inductor L2 is utilized for detecting the inductor current on the inductor L1 so as to generate an inductor current detecting signal VZCD. To prevent the inductor current detecting signal VZCD from being directly fed into the PFC controller 160 to damage or error, a resistor Rb is connected between the auxiliary inductor L2 and the PFC controller 160. The voltage divider converts the output voltage Vo of the DC-to-DC converter circuit into a feedback voltage signal VFB and has the feedback voltage signal VFB fed to the PFC controller 160 for feedback control. In conclusion, the PFC controller 160 in the present embodiment controls the switching unit Q1 based on three detecting signals, the conductive current of the switching unit Q1 detected by using the switching unit current detector 170, the output voltage Vo detected by using the voltage divider, and the inductor current on the inductor L1 detected by using the auxiliary inductor L2.

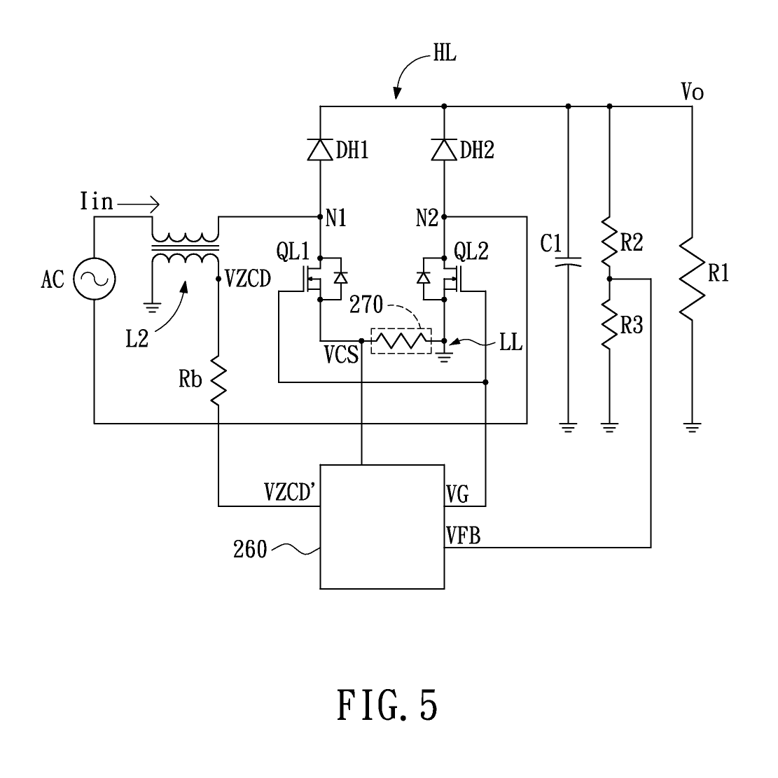

FIG. 5 is a schematic view showing an application circuit for a PFC controller in accordance with another embodiment of the present invention. A bridgeless PFC circuit is described. As shown, the bridgeless PFC circuit includes a converting circuit, a switching unit current detector 270, and a PFC controller 260. The following paragraph describes the distinctions between the application circuit of the present embodiment and that shown in FIG. 4.

The converting circuit has a high-side line HL and a low-side line LL. In the present embodiment, the low-side line LL is grounded. The converting circuit also has a first high-side rectifier unit DH1, a first low-side rectifier unit QL1, a second high-side rectifier unit DH2, a second low-side rectifier unit QL2, an inductor L1, and an output capacitor C1. The first high-side rectifier unit DH1 and the first low-side rectifier unit QL1 are serially connected between the high-side line HL and the low-side line LL. A first node N1 is defined on the circuit between the first high-side rectifier unit DH1 and the first low-side rectifier unit QL1. The second high-side rectifier unit DH2 and the second low-side rectifier unit QL2 are serially connected between the high-side line HL and the low-side line LL also and a second node N2 is defined on the circuit between the second high-side rectifier unit DH2 and the second low-side rectifier unit QL2. The inductor L1 is connected between the ac power source and the first node N1. In addition, the ac power source and the inductor L1 are serially connected between the first node N1 and the second node N2. The output capacitor C1 is connected between the high-side line HL and the low-side line LL.

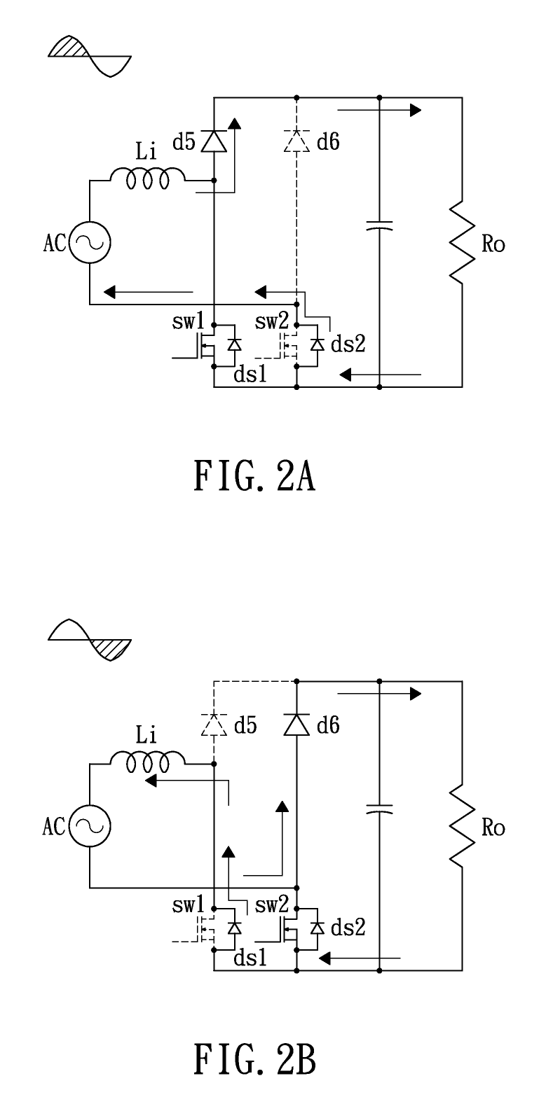

In the present embodiment, the first high-side rectifier unit DH1 and the second high-side rectifier unit DH2 are two diodes forwardly biased between the first node N1 and the high-side line HL as well as the second node N2 and the high-side line HL. The first low-side rectifier unit QL1 and the second low-side rectifier unit QL2 are two switching units. Thus, the topology of the converting circuit in the present embodiment is similar to that shown in FIGS. 2A and 2B. For detecting the conductive current on the switching unit, the switching unit current detector 270 is connected to the switching unit QL1, the switching unit QL2, or both. In addition to the conductive current detected by using the switching unit current detector 270, the PFC controller 260 also detects the inductor current on the inductor L1 by using the auxiliary inductor L2 so as to generate a driving signal DRV for controlling on/off state of the first low-side rectifier unit QL1 and the second low-side rectifier unit QL2.

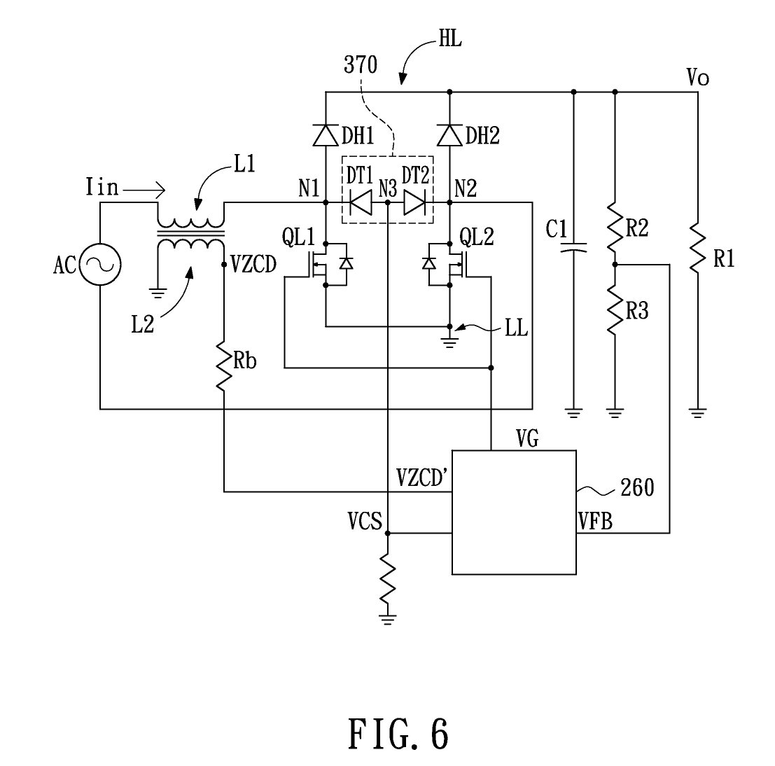

FIG. 6 is a schematic view showing another application circuit for the PFC controller in accordance with an embodiment of the present invention. A main difference between the present embodiment and that shown in FIG. 5 is the switching unit current detectors 270, 370 being used. In the present embodiment, the switching unit current detector 370 includes a first detecting diode DT1 and a second detecting diode DT2. The cathode of the first detecting diode DT1 and the cathode of the second detecting diode DT2 are connected to the first node N1 and the second node N2 respectively. The anode of the first detecting diode DT1 and the anode of the second detecting diode DT2 are joint at a third node, which generates the conductive-current detecting signal VCS. In contrast with the embodiment shown in FIG. 5, which needs a resistor serially connected to the switching units QL1 and QL2 for detecting conductive current, the switching unit current detector 370 is able to reduce conduction loss.

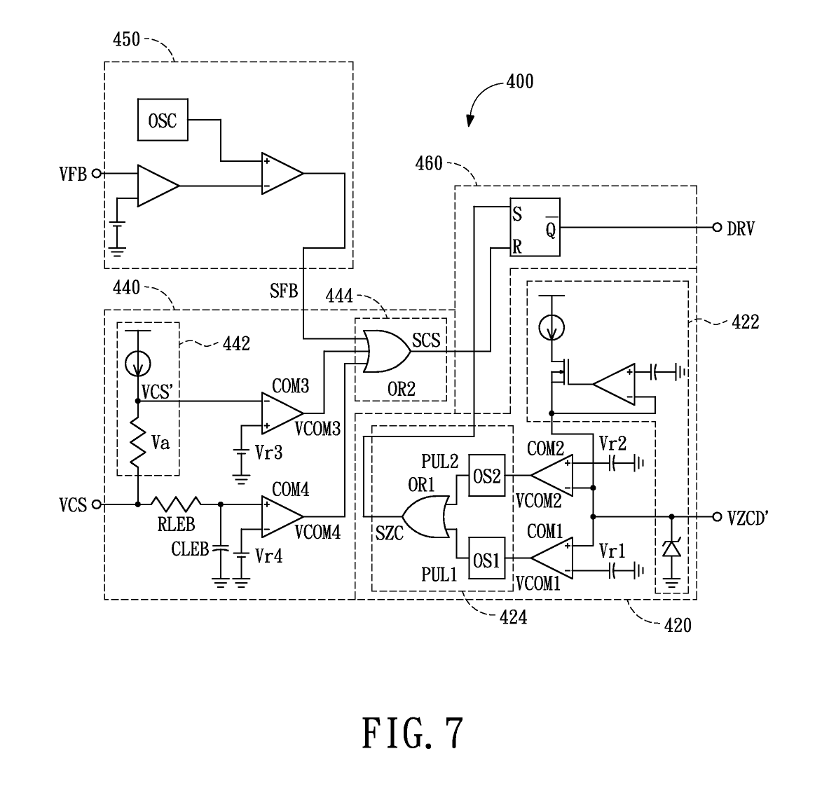

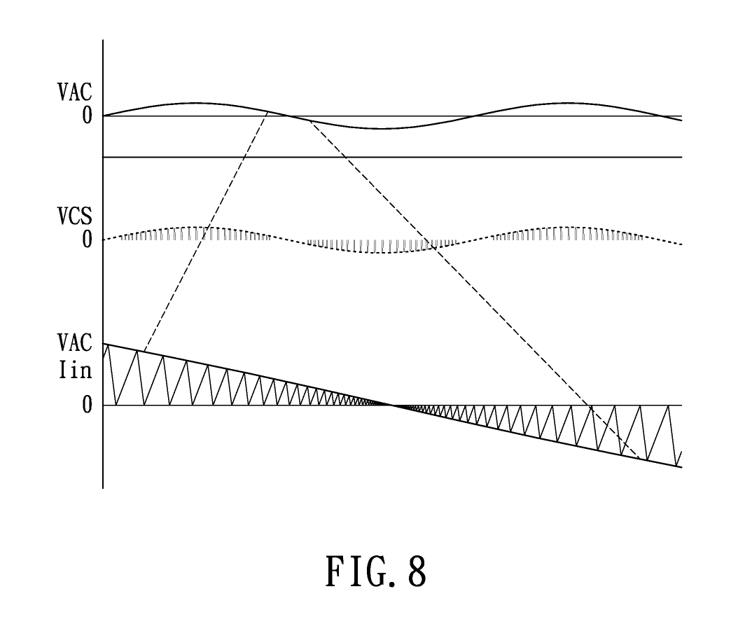

FIG. 7 is a schematic view showing a PFC controller 400 in accordance with an embodiment of the present invention, and the PFC controller 400 applied in the application circuit of FIG. 6 is described below. FIG. 8 shows the respective waveforms in the application circuit, such as the ac voltage input VAC from the ac power source, the conductive-current detecting signal VCS, and the input current lin from the ac power source.

As shown in FIG. 7, the PFC controller 400 includes a zero-current detecting circuit 420, a conductive current detecting circuit 440, a feedback control circuit 450, and a switching control circuit 460. The zero-current detecting circuit 420 includes a first clamp circuit 422, a first comparator COM1, a second comparator COM2, and a first logic circuit 424. The first clamp circuit 422 generates a first clamped signal VZCD′ restricted in a positive potential range at least according to a negative potential portion of the inductor current detecting signal VZCD. The zero-current detecting circuit 420 generates a zero-current signal SZC to turn on the switching unit, which may be the switching unit Q1 in FIG. 4, and the first low-side rectifier unit QL1 and the second low-side rectifier unit QL2 in FIGS. 5 and 6, according to the first clamped signal VZCD′.

In the present embodiment, the first comparator COM1 receives the first clamped signal VZCD′ at a positive input thereof and a first reference level Vr1 at a negative input thereof for generating a first comparing signal VCOM1. The second comparator COM2 receives the first clamped signal VZCD′ at a negative input thereof and a second reference level Vr2 at a positive input thereof for generating a second comparing signal VCOM2. The first logic circuit 424 receives the first comparing signal VCOM1 and the second comparing signal VCOM2 so as to generate the zero-current signal SZC.

In the present embodiment, the first logic circuit 424 has a first one-shot circuit OS1, a second one-shot circuit 0S2, and an OR gate OR1. The first one-shot circuit OS1 receives the first comparing signal VCOM1 and generates a first pulse signal PUL1 according to a level switching time of the first comparing signal VCOM1. The second one-shot circuit OS2 receives the second comparing signal VCOM2 and generates a second pulse signal PUL2 according to a level switching time of the second comparing signal VCOM2. The OR gate OR1 receives the first pulse signal PUL1 and the second pulse signal PUL2 so as to generate the zero-current signal SZC.

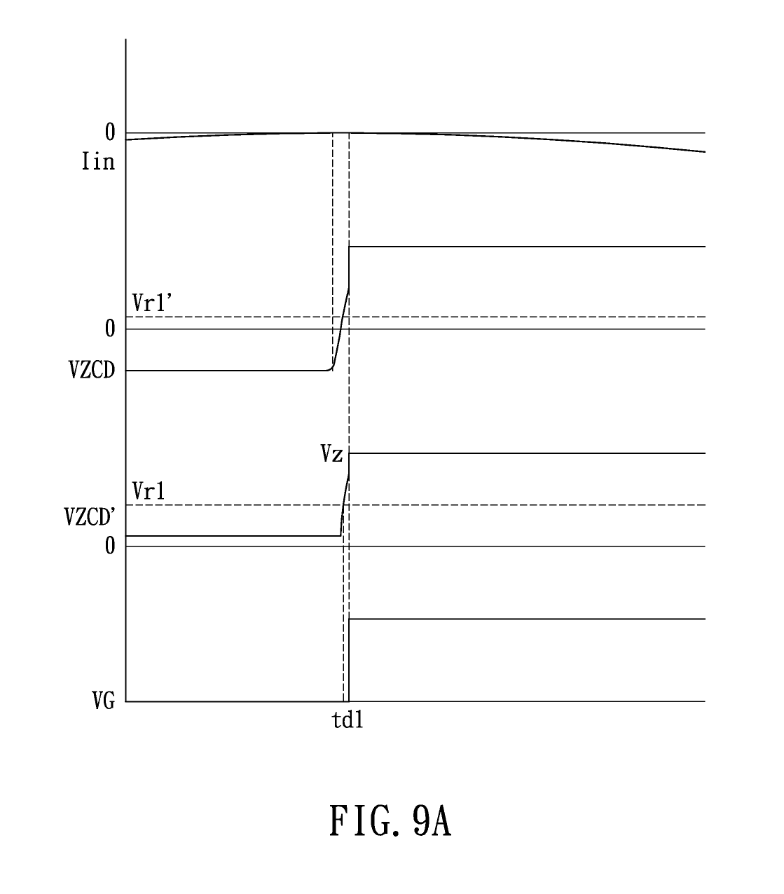

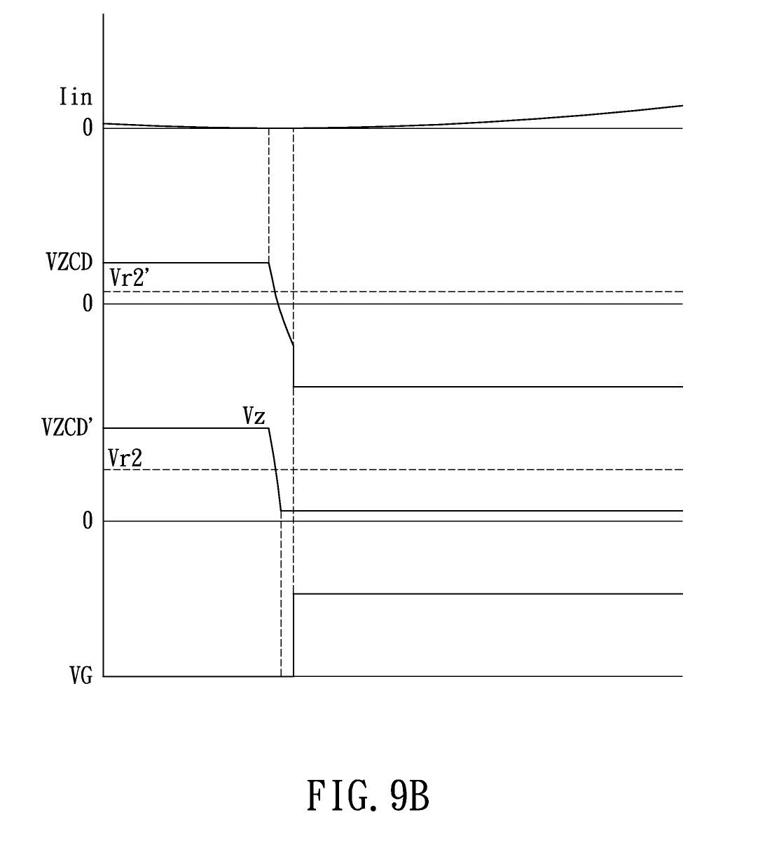

Referring to FIGS. 8 and 9A, during the negative half cycle of the ac voltage input VAC, the value of input current lin is negative, which means the current is flowing from the inductor L1 toward the ac power source AC, and keeps oscillating below zero. Referring to FIG. 9A, as the value of the input current lin raises close to zero, the inductor current detecting signal VZCD is switched from a negative level to a positive level. The inductor detecting signal VZCD is then converted into the first clamped signal VZCD′ varying between a predetermined high level and a predetermined low level by using the first clamp circuit 422. The two predetermined levels are both positive. As a preferred embodiment, the predetermined high level is higher than anyone of the first reference level Vr1 and the second reference level Vr2, but the predetermined low level is located between the first reference level Vr1 and the second reference level Vr2.

The level of the inductor current detecting signal VZCD is dependent to the level of the AC voltage input. The usage of the first clamp circuit 422 for converting the inductor current detecting signal VZCD into the first clamped signal VZCD′ is also to shrink the potential varying range of the inductor current detecting signal VZCD to facilitate flowing operations in the PFC controller 400.

As the level of the first clamped signal VZCD′ rises over the first reference level Vr1, the first comparing signal VCOM1 outputted by the first comparator COM1 would be switched from low to high. The first one-shot circuit OS1 senses level switching of the first comparing signal VCOM1 and generates the first pulse signal PUL1 immediately to raise gate voltage VG of the switching units QL1 and QL2 from low to high to turn on the switching units QL1 and QL2. Then, the ac power source begins charging the inductor L1.

The above mentioned embodiment turns on the switching units QL1 and QL2 according to the comparing result of the first comparator COM1 based on the first clamped signal VZCD′ and the first reference level Vr1. However, the present invention is not so restricted. As shown in FIG. 9A, the inductor current detecting signal VZCD is oscillating between positive and negative values, with the first reference signal Vr1′ being properly set, the comparing result of the inductor current detecting signal VZCD and the first reference signal Vr1′ can be used to control the switching units QL1 and QL2 directly.

Referring to FIGS. 8 and 9A, during the positive half cycle of the ac voltage input VAC, the value of the input current lin is positive, which means the current is flowing from the ac power source to the inductor L1, and keeps oscillating above zero. As shown in FIG. 9B, as the input current lin drops closed to zero, the inductor current detecting signal VZCD is switched from a positive level to a negative level. The inductor current detecting signal VZCD is converted into the first clamped signal VZCD′ restricted in a range between a predetermined high level and a predetermined low level by the first clamp circuit 422. The two predetermined levels are both greater than zero and as a preferred embodiment, the predetermined high level is higher than anyone of the first reference level Vr1 and the second reference level Vr2, and the predetermine low level is located between the first reference level Vr1 and the second reference level Vr2.

When the first clamped signal VZCD′ drops below the second reference level Vr2, the second comparing signal VCOM2 outputted by the second comparator COM2 is switched from low to high. The second one-shot circuit OS2 senses the switching of the second comparing signal VCOM2 and generates the second pulse signal PUL2 to turn on the switching units QL1 and QL2 immediately. Then, the ac power source AC begins charging the inductor L1.

The above mentioned embodiment achieves the object of controlling the timing to turn on the switching units QL1 and QL2 by using the second comparator COM2 to compare the first clamped signal VZCD′ and the second reference level Vr2. However, the present invention is not so restricted. As shown in FIG. 9B, since the inductor current detecting signal VZCD is oscillating above and below zero, with the second reference signal Vr2′ being properly set, the comparing result of the inductor current detecting signal VZCD and the second reference signal Vr2′ can be used to control the timing of turning on the switching units QL1 and QL2. In addition, according to another embodiment, with both the first reference level Vr1′ and the second reference level Vr2′ being properly set, the first clamp circuit 422 can be skipped.

The zero-current detecting circuit 420 detects a first portion of the inductor current detecting signal VZCD with respect to the negative half cycle of the ac voltage input and a second portion thereof with respect to the positive half cycle of the ac voltage input by using the first comparator COM1 and the second comparator COM2 respectively. Thus, the difficulty of detecting inductor current with both directions can be resolved.

The conductive current detecting circuit 440 includes a second clamp circuit 442, a third comparator COM3, a fourth comparator COM4, and a second logic circuit 444. The second clamp circuit 442 generates a second clamped signal VCS′ restricted in a positive potential range at least according to a negative potential portion of a conductive-current detecting signal VCS. The conductive current detecting circuit 440 generates a cutoff signal SCS to turn off the switching units QL1 and QL2 according to the second clamped signal VCS′. The third comparator COM3 receives the second clamped signal VCS′ and a third reference level Vr3 for generating a third comparing signal VCOM3. The fourth comparator COM4 receives the conductive-current detecting signal VCS and a fourth reference level Vr4 for generating a fourth comparing signal VCOM4. The above mentioned third reference level Vr3 and the fourth reference level Vr4 may be identical or not. In the present embodiment, the third reference level Vr3 and the fourth reference level Vr4 are designated with an identical level for simplifying circuit design. The second logic circuit 444 receives the third comparing signal VCOM3 and the fourth comparing signal VCOM4 so as to generate the cutoff signal SCS to turn off the switching units QL1 and QL2.

In the present embodiment, the second clamp circuit 442 is a level shifter for raising the whole negative potential portion of the conductive-current detecting signal VCS with a predetermined level Va so as to generate a second clamped signal VCS′, which is varying within the potential range above zero, and the resulted level equals to the sum of VCS and Va.

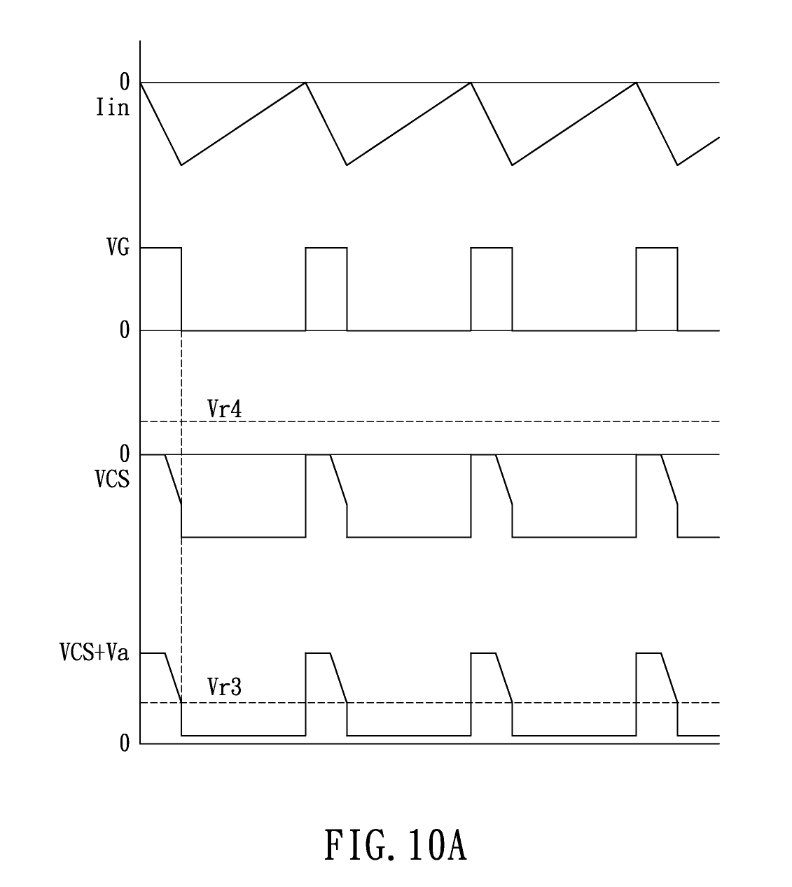

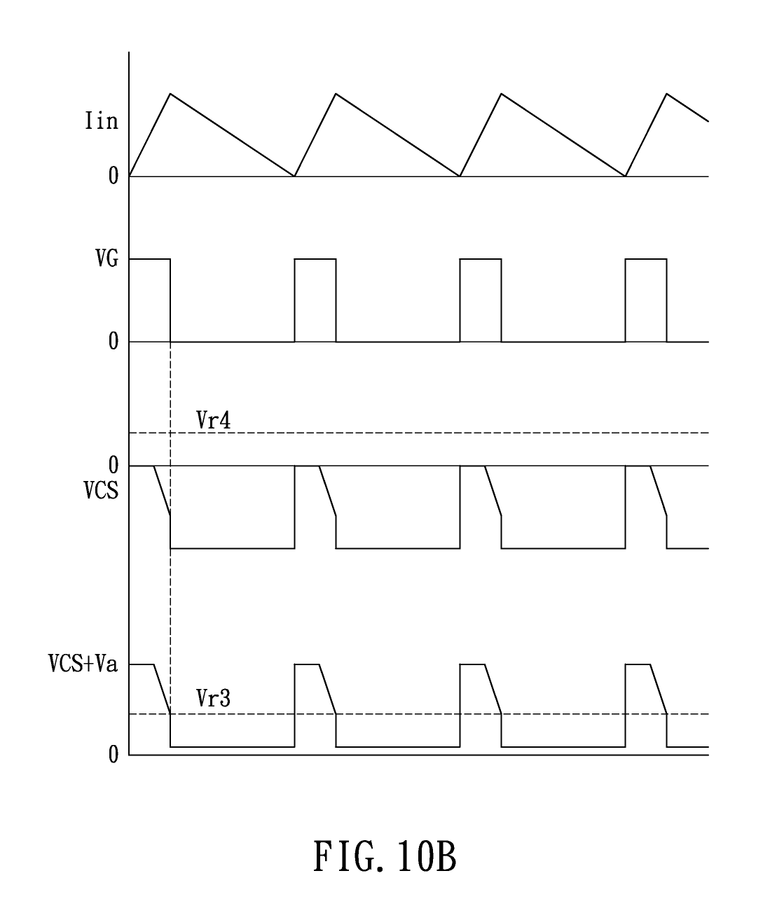

Referring to FIG. 10A, during the negative half cycle of the ac voltage input VAC, the value of the input current lin is oscillating in a range below zero, meanwhile, the conductive-current detecting signal VCS is negative. Since the third reference level Vr3 is positive and the conductive-current detecting signal VCS is negative, the third comparator COM3 may continuously output low level third comparing signal VCOM3. However, because the level of the conductive-current detecting signal VCS is raised by the second clamp circuit 442 with a predetermined level Va, that the third reference level Vr3 should be designated as located in the potential varying range of the resulted second clamped signal VCS′.

After the switching units QL1 and QL2 are turned on (the gate voltage VG is high), the power source AC begins charging the inductor L1 through the switching units QL1 and QL2. At this time, the level of the conductive-current detecting signal VCS would be gradually declined attending with increasing of the absolute value of the input current lin. As the second clamped signal VCS′ drops to a level lower than the third reference level Vr3, the third comparator COM3 outputs the high level third comparing signal VCOM3 to cut off the switching units QL1 and QL2.

Also referring to FIGS. 6 and 10A, the switching unit current detector 370 is able to detect the conductive current of the switching unit QL1 or QL2 after potential difference between the second node N2 and the third node N3 or the first node N1 and the third node N3 overcomes voltage drop of the detecting diode DT1 or DT2 under forward biased condition. In more detail, right after the switching units QL1 and QL2 are conducted, the level of the first node N1 is not low enough to conduct the detecting diode DT1 and the level of the conductive-current detecting signal VCS would be remained at zero. Then, as potential difference between the first node N1 and the third node N3 reaches voltage drop of the detecting diode DT1, the level of the conductive-current detecting signal VCS begins to gradually decline attending with the increasing of conductive current flowing through the switching unit QL1.

On the other hand, as shown in FIG. 10B, during the positive half cycle of the ac voltage input VAC, the value of the input current lin is oscillating in a range above zero. However, since the switching unit current detector 370 can be used to detect conductive current of the switching unit QL1 or QL2 as potential difference between the second node N2 and the third node N3 or the first node N1 and the third node N3 reaches voltage drop of the detecting diode DT1 or DT2 under forward biased condition, the waveform of the conductive-current detecting signal VCS would be identical to that during the negative half cycle of the ac voltage input VAC. Therefore, the conductive current detecting circuit 440 turns off the switching units QL1 and QL2 essentially according to the comparing result of the comparator COM4 also.

Back to FIG. 7, the PFC controller 400 also has a feedback control circuit 450 utilized for turning off the switching units QL1 and QL2. Also referring to FIGS. 4, 5, and 6, the feedback control circuit 450 accesses a feedback voltage signal VFB with respect to the output voltage through a voltage divider, which is composed of resistors R2 and R3, and generates a feedback control signal SFB accordingly. In the present embodiment, the feedback control signal SFB, the third comparing signal VCOM3, and the fourth comparing signal VCOM4 are fed in the OR gate OR2 for generating the cutoff signal SCS. However, the present invention is not so restricted. The third comparing signal VCOM3 and the fourth comparing signal VCOM4 may be fed in an OR gate first, and then the output of the OR gate and the feedback control signal SFB are fed into another OR gate for generating the cutoff signal SCS to turn off the switching units QL1 and QL2.

The switching control circuit 460 of the PFC controller 400 has a flip-flop. The set and reset inputs of the flip flop receives the zero-current signal SZC and the cutoff signal SCS respectively, and the inverted output QB of the flip-flop outputs a driving signal DRV to control on/off state of the switching units QL1 and QL2. In the present embodiment, the level of the driving signal DRV is reversely related to the gate voltage of the switching units QL1 and QL2. However, the present invention is not so restricted. The non-inverted output of the flip-flop or both the inverted and non-inverted outputs of the flip-flop may be used for providing the driving signal DRV if the driving circuit connected to the switching control circuit 460, the switching unit, or the converting circuit topology are changed.

The condition the PFC controller of FIG. 7 being applied in the application circuit of FIG. 5 would be different attending with the switching unit current detector 270 being used. As the current flowing through the switching units QL1 and QL2 are detected by using the switching unit current detector 270 characterized with a resistor, the waveforms of the conductive-current detecting signal VCS during positive half cycle and negative half cycle of the ac voltage input VAC would be different.

During the positive half cycle of the ac voltage input VAC, the level of the conductive-current detecting signal VCS would be gradually increased attending with the increasing of conductive current flowing through the switching units QL1 and QL2. At this time, the second clamped signal VCS′ generated by the second clamp circuit 442 would be maintained above the third reference level Vr3, and the third comparator COM3 may consistently output the low level third comparing signal VCOM3. However, the level of the fourth reference level Vr4 is designated as located in the potential varying range of the conductive-current detecting signal VCS. As the conductive-current detecting signal VCS is raised above the fourth reference level Vr4, the fourth comparator COM4 may output the fourth comparing signal VCOM4 to turn off the switching units QL1 and QL2.

During the negative half cycle of the ac voltage input VAC, the conductive-current detecting signal VCS is negative and would be more negative attending with the increasing of conductive current flowing through the switching units QL1 and QL2. Meanwhile, the level of the conductive-current detecting signal VCS would be kept below the fourth reference level Vr4 and the fourth comparator COM4 may consistently output the low level fourth comparing signal VCOM4. On the other hand, for the third comparator COM3, the level of the conductive-current detecting signal VCS would be raised by the second clamp circuit 442 so as to generate the second clamped signal VCS′, and the third reference level Vr3 should be designate as located in the potential varying range of the second clamped signal VCS′. As the level of the second clamped signal VCS′ is declined below the third reference level Vr3, the third comparator COM3 would output the high level third comparing signal VCOM3 to turn off the switching units QL1 and QL2.

As mentioned above, the conductive current detecting circuit 440 of the present embodiment detects conductive current flowing through the switching units QL1 and QL2 with respective to positive half cycle and negative half cycle of the ac voltage input VAC by using the third comparator COM3 and the fourth comparator COM4 respectively such that the difficulty for traditional PFC control to detect conductive current flowing through the switching units QL1 and QL2 with both directions can be resolved.

In the embodiment shown in FIG. 7, the first clamped signal VZCD′, which is generated by using the first clamp circuit 422, is fed to the positive input of the first comparator COM1 and negative input of the second comparator COM2. In contrast, the second clamp circuit 422, which may be a level shifter as shown, merely delivers the resulted second clamped signal VCS′ to the negative input of the third comparator COM3, and the positive input of the fourth comparator COM4 receives the original conductive-current detecting signal VCS instead for flowing comparison.

The clamp circuits applied in the zero-current detecting circuit 420 and the conductive current detecting circuit 440 may be chosen according to the level of the signals to be detected, the potential varying range, the reference level, and etc., and should not be so restricted. In addition, since the waveform of the conductive-current detecting signal generated by the switching unit current detector 370 in the embodiment of FIG. 6 would not be influenced by the direction of conductive current, the fourth comparator COM4 may be skipped without interfering normal operation of the controller.

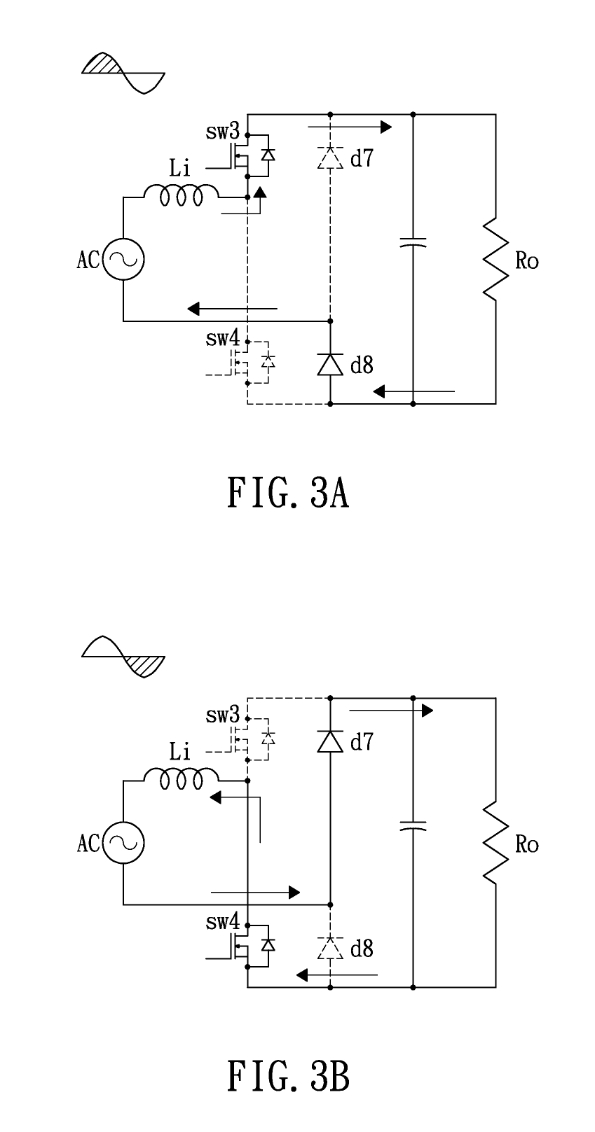

The PFC controller described in the present invention can be applied to not only the bridgeless PFC application circuit as shown in FIGS. 5 and 6, but also the traditional full-bridge PFC application circuit as shown in FIG. 4. In addition, the aforementioned embodiment described based on the bridgeless PFC application circuit shown in FIGS. 5 and 6 is merely an example for the present invention. The technological features of the PFC controller described in present invention are directed to the current detecting issues raised by the ac voltage input VAC, which should not be regarded as a restriction to the type of applicable PFC circuits. With the driving circuit of the PFC controller being properly adjusted, the PFC controller in the present invention may be applied to the bridgeless PFC application circuit as shown in FIGS. 3A and 3B or the others. In addition, although the driving signal DRV described in FIG. 7 is utilized for simultaneously controlling on/off state of the switching units QL1 and QL2, the present invention is not so restricted. With the driving signal DRV being adequately adjusted, it can be used to drive two alternatively conducted switching units for the need of other bridgeless PFC topologies.

No matter during the positive half cycle or the negative half cycle of the ac voltage input, the PFC controller is able to detect the inductor current and the conductive current flowing through the switching unit effectively. Thus, the controlling issues for bridgeless PFC applications can be solved. In addition, the PFC controller provided in the present invention can be also used to control the traditional full-bridge PFC converter in addition to the PFC bridgeless converter.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

What is claimed is:

1. A power factor correction (PFC) controller, for controlling at least a switching unit, the PFC controller comprising:
a feedback control circuit, generating a feedback control signal for controlling the switching unit according to a feedback voltage signal;
a conductive current detecting circuit, having a second clamp circuit, which generates a second clamped signal restricted in a positive potential varying range at least according to a negative potential portion of a conductive-current detecting signal, and generating a cutoff signal to turn off the switching unit at least according to the second clamped signal; and
a switching control circuit, for turning off the switching unit according to the feedback control signal and the cutoff signal.

2. The PFC controller of claim 1, further comprising a zero-current detecting circuit, which generates a zero-current signal at least according to an inductor current detecting signal, and the switching control circuit turning on the switching unit according to the zero-current signal.

3. The PFC controller of claim 2, wherein the zero-current detecting circuit includes a first clamp circuit, which generates a first clamped signal restricted in a potential varying range at least according to a negative potential portion of the inductor current detecting signal, and generates the zero-current signal at least according to the first clamped signal.

4. The PFC controller of claim 1, wherein the switching control circuit includes a flip-flop.

5. The PFC controller of claim 3, wherein the zero-current detecting circuit includes a first comparator, a second comparator, and a first logic circuit, the first comparator receives the first clamped signal at a positive input thereof and a first reference level at a negative input thereof so as to generate a first comparing signal, the second comparator receives the first clamped signal at a negative input thereof and a second reference level at a positive input thereof so as to generating a second comparing signal, and the first logic circuit generates the zero-current signal according to the first comparing signal and the second comparing signal.

6. The PFC controller of claim 5, wherein the first logic circuit includes a first one-shot circuit, a second one-shot circuit, and an or gate, the first one-shot circuit receives the first comparing signal and generates a first pulse signal at a level switching time of the first comparing signal, the second one-shot circuit receives the second comparing signal and generates a second pulse signal at a level switching time of the second comparing signal, and the or gate receives the first pulse signal and the second pulse signal for generating the zero-current signal.

7. The PFC controller of claim 1, wherein the conductive current detecting circuit includes a third comparator, a fourth comparator, and a second logic circuit, the third comparator receives the second clamped signal and a third reference signal for generating a third comparing signal, the fourth comparator receives the conductive-current detecting signal and a fourth reference signal for generating a fourth comparing signal, and the second logic circuit generates the cutoff signal at least according to the third comparing signal and the fourth comparing signal.

8. The PFC controller of claim 7, wherein the second logic circuit generates the cutoff signal at least according to the feedback control circuit, the third comparing signal, and the fourth comparing signal.

9. The PFC controller of claim 1, wherein the second clamp circuit is a level shifter.

10. A bridgeless PFC circuit, comprising:
a converting circuit, having a high-side line and a low-side line, and comprising:
a first high-side rectifier unit and a first low-side rectifier unit, serially connected between the high-side line and the low-side line and a first node being defined on a circuit therebetween;
a second high-side rectifier unit and a second low-side rectifier unit, serially connected between the high-side line and the low-side line and a second node being defined on a circuit therebetween;
at least an inductor, connected between a power source and the first node, and the inductor and the power source being serially connected between the first node and the second node; and
an output capacitor, connected between the high-side line and the low-side line;
wherein at least one of the first high-side rectifier unit, the first low-side rectifier unit, the second high-side rectifier unit, and the second low-side rectifier unit is a switching unit;
a switching unit current detector, connected to the switching unit for detecting a conductive current flowing through the switching unit to generate a conductive-current detecting signal; and
a PFC controller, comprising:
a feedback control circuit, generating a feedback control signal for controlling the switching unit according to a feedback voltage signal with respect to an output voltage of the converting circuit;
a conductive current detecting circuit, having a second clamp circuit, which generates a second clamped signal restricted in a positive potential varying range at least according to a negative potential portion of the conductive-current detecting signal, and generating a cutoff signal for turning off the switching unit at least according to the second clamped signal; and
a switching control circuit, for turning off the switching unit according to the feedback control signal and the cutoff signal.

11. The bridgeless PFC circuit of claim 10, wherein the PFC controller further comprises a zero-current detecting circuit, which generates a zero-current signal at least according to an inductor current detecting signal, and the switching control circuit turns on the switching unit according to the zero-current signal.

12. The bridgeless PFC circuit of claim 11, wherein the zero-current detecting circuit includes a first clamp circuit, which generates a first clamped signal restricted in a potential varying range at least according to a negative potential portion of the inductor current detecting signal, and generates the zero-current signal at least according to the first clamped signal.

13. The bridgeless PFC circuit of claim 10, wherein the switching control circuit includes a flip-flop.

14. The bridgeless PFC circuit of claim 12, wherein the zero-current detecting circuit further includes a first comparator, a second comparator, and a first logic circuit, the first comparator receives the first clamped signal at a positive input thereof and a first reference level at a negative input thereof for generating a first comparing signal, the second comparator receives the first clamped signal at a negative input thereof and a second reference level at a positive input thereof for generating a second comparing signal, and the first logic circuit generates the zero-current signal according to the first comparing signal and the second comparing signal.

15. The bridgeless PFC circuit of claim 14, wherein the first logic circuit includes a first one-shot circuit, a second one-shot circuit, and an or gate, the first one-shot circuit receives the first comparing signal and generates a first pulse signal at a level switching time of the first comparing signal, the second one-shot circuit receives the second comparing signal and generates a second pulse signal at a level switching time of the second comparing signal, and the or gate receives the first pulse signal and the second pulse signal for generating the zero-current signal.

16. The bridgeless PFC circuit of claim 10, wherein the conductive current detecting circuit includes a third comparator, a fourth comparator, and a second logic circuit, the third comparator receives the second clamped signal and a third reference level for generating a third comparing signal, the fourth comparator receives the conductive-current detecting signal and a fourth reference level for generating a fourth comparing signal, and the second logic circuit generates the cutoff signal at least according to the third comparing signal and the fourth comparing signal.

17. The bridgeless PFC circuit of claim 10, wherein the second clamp circuit is a level shifter.

18. The bridgeless PFC circuit of claim 10, wherein the switching unit current detector includes a resistor connected to the switching unit for converting the conductive current into the conductive-current detecting signal.

19. The bridgeless PFC circuit of claim 10, wherein the switching unit current detector includes a first detecting diode and a second detecting diode, a cathode of the first detecting diode is connected to the first node, a cathode of the second detecting diode is connected to the second node, and an anode of the first detecting diode and an anode of the second detecting diode are connected at a third node for generating the conductive-current detecting signal.

20. The bridgeless PFC circuit of claim 10, wherein the first high-side rectifier unit and the second high-side rectifier unit are two rectifier diodes forwardly connected between the first node and the high-side line as well as the second node and the high-side line respectively, and the first low-side rectifier unit and the second low-side rectifier unit are two switching units controlled by the PFC controller.
